(19) United States
(12) Patent Application Publication
(10) Pub. No.: US 2025/0326457 A1
(43) Pub. Date: Oct. 23, 2025

(54) HANDLEBAR STABILIZING ASSEMBLY

(71) Applicant: Richard Valois, Lansdale, PA (US)

(72) Inventor: Richard Valois, Lansdale, PA (US)

(21) Appl. No.: 19/184,267

(22) Filed: Apr. 21, 2025

Related U.S. Application Data
(60) Provisional application No. 63/636,937, filed on Apr. 22, 2024.

(51) Int. Cl. B62K 21/16

(52) U.S. Cl. CPC B62K 21/16

(57) ABSTRACT

A motorcycle handlebar assembly is disclosure. The handlebar assembly separately engages the front fork of the motorcycle and handlebar of the motorcycle by way of respective engagers that are operatively associated to define pre-locked adjustable engagement between the handlebar and the front fork. The second coupling component provides a fastener hole that directs a fastener into an attachment point of the handlebar, thereby moving the assembly from the pre-locked adjustable engagement to a locked engagement directly and physically fixing the handlebar orientation relative to the front fork. The locked engagement eliminates the risk of gradual loosening and unintended rotational movement caused by vibrations, shocks, or dynamic riding forces, as well as reducing maintenance and eliminates the need for frequent manual readjustments, ensuring lasting stability, rider comfort, and precise motorcycle control.

### CROSS REFERENCE TO RELATED APPLICATION

This application claims the benefit of priority of U.S. provisional application No. 63/636,937, filed Apr. 22, 2024 the contents of which are herein incorporated by reference.

### BACKGROUND OF THE SUBJECT DISCLOSURE

The present subject disclosure relates to motorcycle handlebar assemblies and systems and, more particularly, to a motorcycle handlebar assembly configured to prevent the handlebar from rotating within its mount.

The subject disclosure directly addresses a critical and persistent problem in motorcycle handlebar technology—namely, the unintended rotation, movement, or slippage of motorcycle handlebars during normal riding conditions. Existing motorcycle handlebar systems, especially those utilizing clamp-based mechanisms, inherently depend on friction and are thus prone to gradual loosening over time due to consistent vibration, mechanical shock, and dynamic forces associated with riding. Such unintended handlebar movement—and resulting loosened state of the handlebar—can significantly compromise rider control, diminish ergonomic comfort, lead to rider fatigue and discomfort, and pose substantial safety hazards, including contributing directly to accidents or loss of motorcycle control. Moreover, traditional clamp-based systems require complicated installations and frequent manual readjustments, while limiting usability and reliability, thereby compounding the safety and ergonomic problems faced by motorcycle riders.

Existing motorcycle handlebar systems predominantly rely on friction-based clamps, which inherently weaken and loosen due to continuous vibration, mechanical shocks, and dynamic forces experienced during normal motorcycle operation. Such inherent instability leads to unintended handlebar movement or rotation, critically undermining rider safety, comfort, and vehicle control.

Furthermore, these friction-based systems require frequent manual adjustments and retightening, presenting practical inconvenience, ongoing maintenance burdens, and reduced reliability over time. Additionally, the complexity associated with precisely aligning and securing friction-based clamps often necessitates specialized tools or advanced mechanical knowledge, limiting accessibility and usability for typical motorcycle users. Consequently, these cumulative shortcomings result in persistent ergonomic issues, compromised rider control, and elevated risk of accidents or injury.

These existing friction-based handlebar clamp systems inherently rely on surface friction alone, a force insufficient to withstand prolonged exposure to vibrations, mechanical shocks, and dynamic riding stresses, inevitably causing gradual loosening and loss of secure positioning. Over time, this loosening allows handlebars to rotate or shift unexpectedly, compromising rider safety, comfort, and precise motorcycle handling. The frequent necessity for manual readjustment disrupts riding continuity, creates inconvenience, and increases maintenance requirements. Additionally, the installation and precise adjustment processes of friction clamps are often complicated, requiring specialized tools and mechanical expertise beyond the capabilities of the average rider. Consequently, these intrinsic limitations significantly diminish both the reliability and overall effectiveness of traditional handlebar systems.

As can be seen, there is a need for a handlebar assembly configured to prevent the handlebar from rotating within its mount.

### SUMMARY OF THE SUBJECT DISCLOSURE

The subject disclosure fundamentally improves upon existing systems by replacing friction-dependent handlebar clamps with a uniquely robust bolt-through pinning mechanism, which physically secures the handlebar through direct mechanical engagement. This innovative approach eliminates the risk of gradual loosening and unintended rotational movement caused by vibrations, shocks, or dynamic riding forces. Moreover, the subject disclosure likewise reduces maintenance by eliminating the need for frequent manual readjustments, ensuring lasting stability, rider comfort, and precise motorcycle control. Installation is simplified, accessible, and reliable, as it no longer requires specialized tools or extensive mechanical expertise. Thus, the subject disclosure achieves a marked advancement in safety, ergonomic performance, user convenience, and overall reliability compared to traditional friction-based handlebar clamp technologies.

The subject disclosure embodies a unique bolt-through locking mechanism integrated within the handlebar clip-on system. Specifically, the subject disclosure employs a strategically positioned bolt that is threaded securely through a corresponding hole in a clip-on component, which extends directly into and pins through an aligned, pre-drilled hole in the motorcycle handlebar itself. This direct mechanical pinning ensures that, once properly positioned, the handlebar remains permanently and reliably secured against rotation, slippage, or unintended positional shifts, thereby significantly enhancing motorcycle safety, ergonomic comfort, rider control, and overall reliability compared to existing friction-dependent clamp-based systems.

The subject disclosure distinctly improves upon existing motorcycle handlebar systems by replacing traditional friction-based clamps with a novel bolt-through pinning mechanism, effectively eliminating unintended handlebar rotation and slippage. Unlike prior art, which relies solely on clamp friction—prone to loosening from vibrations and riding stresses—the subject disclosure utilizes a strategically positioned bolt passing directly through a clip-on component that engages the handlebar so that the fastener also directly connects through the handlebar, thereby ensuring permanent, reliable fixation. Consequently, riders no longer face the persistent ergonomic and safety issues associated with frequent readjustments or unexpected handlebar movements. Furthermore, the subject disclosure simplifies installation and maintenance, requiring no specialized tools or extensive mechanical knowledge, thus significantly enhancing accessibility and usability. Collectively, these unique improvements establish a new standard of safety, ergonomic stability, and rider comfort unmatched by current handlebar technologies.

Unlike prior art that utilizes solely friction-based clamps, the present disclosure introduces a direct pinning mechanism that mechanically couples the handlebar and fork assembly, thereby eliminating positional drift, a recurring safety issue unaddressed by conventional designs.

In one aspect of the present subject disclosure, a handlebar locking assembly for a vehicle includes the following: a first coupling component configured to directly engage with and mechanically communicate the first coupling component relative to a steering axis component of the vehicle; a second coupling component configured to directly engage with and mechanically communicate the second coupling component relative to an elongated control member of the vehicle; wherein, in an unlocked state, an angular orientation of the elongated control member relative to the steering axis component is adjustable without tools; a channel defined through at least a portion of the second coupling component, the channel being in communication with the elongated control member directly engaged by the first coupling component; and a securing element configured to move within the channel between a disengaged position and an engaged position in which the securing element physically interferes with the elongated control member to lock said angular orientation in a locked state.

In another aspect of the present subject disclosure, the handlebar locking assembly further includes the following: an attachment point along the elongated control member so that in the locked state the securing element physically and directly engages the attachment point, wherein the first coupling component and the second coupling component are physically connected, wherein the first coupling component provides a first engagement point that directly physically contacts the steering axis component of the vehicle, wherein the second coupling component provides a second engagement point that directly engages with the elongated control member, wherein the first engagement point is a first void that extends in a first direction, wherein the second engagement point is a second void that extends in a second direction, approximately orthogonal relative to the first direction, wherein the channel extends in a third direction, approximately orthogonal relative to the first direction and the second direction, wherein the first coupling component and the first coupling component are each clips, wherein the channel and the securing element are both complementarily threaded, where, in the unlocked state, elongated control member is enabled to rotate, within the second void, about an axis of rotation extending in the second direction, and wherein the first coupling component and the second coupling component are fixed relative to each other.

The term toolless means accomplishable without tools and thus can be done by hand without the application of above-average human strength.

These and other features, aspects and advantages of the present subject disclosure will become better understood with reference to the following drawings, description and claims.

### BRIEF DESCRIPTION OF THE DRAWINGS

FIG. 1 is a perspective view of an exemplary embodiment of the subject disclosure, shown disengaged from a holed handlebar 5.

FIG. 2 is a perspective view of an exemplary embodiment of the subject disclosure, illustrating engagement with the holed handlebar 5.

FIG. 3 is a perspective view of an exemplary embodiment of the subject disclosure, illustrating a partially inserted fastener 4.

FIG. 4 is a perspective view of an exemplary embodiment of the subject disclosure, illustrating a fully inserted fastener 4.

FIG. 5 is a perspective view of an exemplary embodiment of the subject disclosure.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

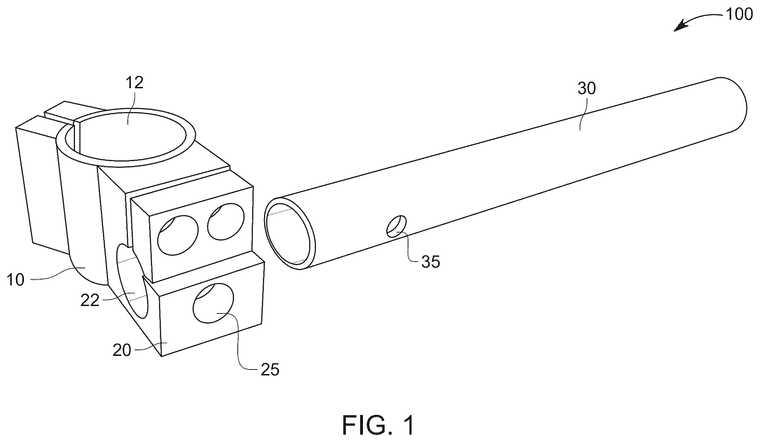

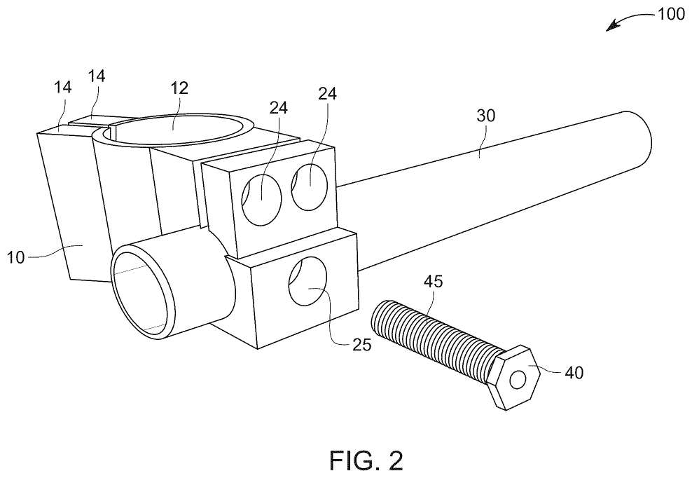

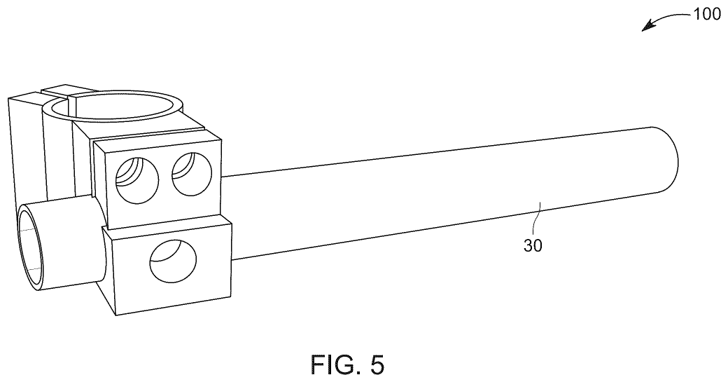

Referring to FIGS. 1 through 5, the subject disclosure provides a control member stabilizing assembly 100 for a vehicle. The control member stabilizing assembly 100 includes a first coupling component 10 and a second coupling component 20.

The first coupling component 10 provides a first engagement point 12 dimensioned and adapted to directly engage a steering axis component of a vehicle (not shown), whereby the first coupling component 10 is fixed relative to said steering axis component. The second coupling component 20 has a second engagement point 22 for engaging an elongated control member 30 of the vehicle so that the second coupling component 20 and the elongated control member 30 are fixed relative to each other.

It being understood that even though the present disclosure typically refers to ‘motorcycles’, that the subject disclosure is applicable to any vehicle with a handlebar used for steering purposes. This includes any motor or non-motorized vehicle steered by a handlebar (which is included, but not limited, by the term ‘elongated control component’), and wherein the steering axis component is typically the front fork of bike-related vehicles or equivalent on other vehicles.

The first engagement point 12 may be a void occupiable by said steering axis component, though any method of physically establishing a fixed relationship between the front first coupling component 10 and said front fork is contemplated by the subject disclosure. In some embodiments, the void may be an open-ended channel which could receive said steering axis component so that a surface defining the void may engage said front fork. In some embodiments, the first coupling component 10 is a clip body defining a hole through which said steering axis component is received, whereby the clip body is configured to selectively clamp or otherwise be urged against said front fork/steering axis component under a force imparted by fastening devices or the like. To this end the first coupling component 10 may provide fastener holes, spaced apart flanges 14, or other elements to assist in the impartment of the necessary fixing force. Again, any structure known or subsequently invented that facilitates the fixed engagement of the front first coupling component 10 and said front fork is contemplated by the subject disclosure.

It being understood that the second engagement point 22 may be a void occupiable by the handlebar 30, though any method of physically establishing a fixed relationship between the second coupling component 20 and the elongated control member 30 is contemplated by the subject disclosure. In some embodiments, the void may be an open-ended channel which could receive the elongated control member 30 so that a surface defining the void may engage said front fork. In some embodiments, second coupling component 20 is a clip body defining a hole through which the elongated control member 30 is received, whereby the clip body is configured to selectively clamp or otherwise be urged against the elongated control member 30 under a force imparted by fastening devices or the like. To this end the second coupling component 20 may provide fastener holes 24 or other elements to assist in the impartment of the necessary fixing force. Again, any structure known or subsequently invented that facilitates the fixed engagement of the second coupling component 20 and the elongated control member 30 is contemplated by the subject disclosure.

The first coupling component 10 and the second coupling component 20 are operatively associable so that the engaged front fork and the separately engaged handlebar 30 are fixed relative to each other. This operative association may be a fixed connection, an adjustable connection or any other connection that enables the disclosure herein.

The elongated control member 30 provides an attachment point 35 dimensioned and positioned along the elongated control member 30 so that the attachment point 35 occupies the handle engagement point 22 when the elongated control member 30 is engaged by the second coupling component 20.

The body of the second coupling component 20 provides a channel 25 that communicates the external environment with the second engagement point 22 so that a securing element 40 journalled through the channel 25 can selectively operatively associate with the attachment point 35 of the elongated control member 30, thereby forming a fixed relationship of the elongated control member 30 relative to the second coupling component 20. Prior to this formation of the fixed relationship the handlebar 30 can spin or rotate relative to the handle engagement point 22, which in turn enables the user to facilitate the formation of the fixed relationship by rotating the handlebar 30 until its attachment point 35 aligns with the fastener 40 seeking to protrude into the handle engagement point 22 by way of the through hole 25.

The securing element 40 may be, but is not limited to, a threaded fastener with a threaded body 45. The through hole 25 and, in some embodiments, the attachment point 35 of the elongated control member 30 may have internal threading complementary to the threaded body 45. In other embodiments, where the securing element 40 is a screw, it could be threaded through the channel 25 and then pinned through the attachment point 35.

The subject disclosure components interact clearly and logically to create a secure and stable control member stabilizing assembly 100: the first coupling component 10 attaches securely to the motorcycle's front fork, forming the foundation for mounting the elongated control member 30. The second coupling component 20 attaches to the first coupling component 10, so that the second coupling component 20 directly holds the elongated control member 30 in place, serving as the primary connection point for elongated control member 30 stability and positioning. The channel 25 located within the structure of the second coupling component 20 may be a precisely engineered threaded hole critical for securing the handlebar 30 in place. The threaded fastener/securing element 40 may be secured through the threaded channel 25, extending further into a, in some embodiments, pre-drilled hole/attachment point 35 in the handlebar 30. Its function is to pin and lock the elongated control member 30 firmly in position, preventing any unintended rotation or movement.

The first coupling component 10 serves as a secure foundational mount, designed specifically to attach firmly onto the motorcycle's front fork. Its structural integrity ensures the stability and strength necessary to anchor the entire control member stabilizing assembly 100 in place, thereby fulfilling its essential role in maintaining a fixed positional relationship with the motorcycle frame.

The second coupling component 20 receives, holds, and supports the motorcycle handlebar 30. It enables precise positioning and ergonomic customization for riders. Its functional design ensures it can securely maintain handlebar orientation once adjustments have been completed. A strategically positioned, precision-engineered threaded hole 25 within the second coupling component 20 is critically important as it provides the passageway and threaded engagement required to reliably anchor the threaded fastener 40, facilitating the robust mechanical linkage between the second coupling component 20 and the handlebar 30. In certain embodiments, the fastener 40 is a specially designed bolt to operatively associate through the through hole 25 to extend into, and pins through, a pre-drilled hole 35 in the motorcycle handlebar 30. Its primary purpose is to serve as a mechanical pinning mechanism, physically preventing any rotational or translational movement between the handlebar 30 and the second coupling component 20, ensuring positional stability.

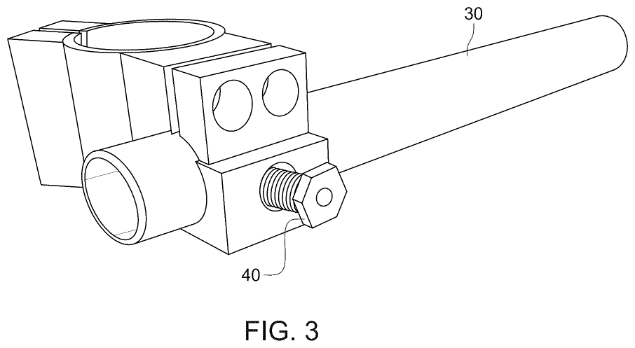

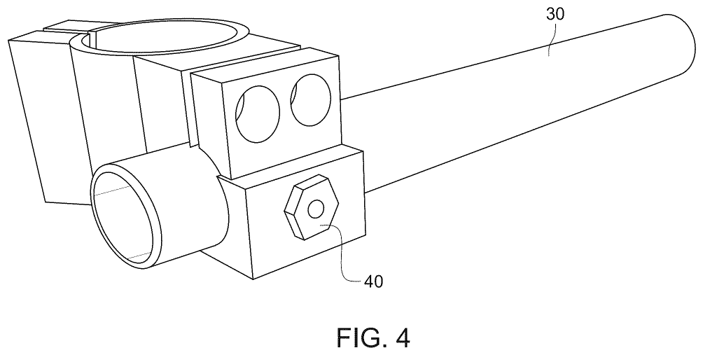

FIGS. 3 and 4 illustrate clearly how the fastener 40 passes through the second coupling component 20 into the handlebar 30. This ensures a comprehensive understanding of the functional relationship and positional accuracy necessary to achieve the disclosure's secure and stable locking mechanism. The combined functionality and interactivity of the disclosure enables the desired function through the deliberate and interdependent interaction among all components, outlined in the following procedural steps. Step 1: the installer securely attaches the front-first coupling component 10 to the motorcycle's front fork, creating a robust and stable base platform necessary for overall stability. Step 2: the second coupling component 20 is subsequently positioned onto the handlebar, allowing precise adjustment of the handlebar's ergonomic angle and alignment according to the rider's preference. Step 3: with the handlebar 30 correctly positioned, alignment is established between said threaded hole 25 within the second coupling component 20 and the corresponding pre-drilled hole in the handlebar 30 itself. This alignment is critical for the subsequent pinning function. Step 4: the specially designed fastener 40 is threaded through the second coupling component 20 channel 25 subsequently passing into and through the aligned hole/attachment point 35 in the control member 30. Upon tightening, this securing element 40 effectively pins and locks the handlebar in position, physically eliminating potential rotational or slippage movement. Step 5: the assembly 10 explicitly verifies and clarifies the alignment and secure placement of the bolt, further reinforcing the structural understanding and precision of the connection, thereby creating a uniquely robust and stable handlebar locking mechanism.

Manufacturing or fabricating the subject disclosure may involve high-strength aluminum, alloys or steel, precision-machined to match motorcycle front fork dimensions, ensuring stable and secure mounting. Also, CNC machining, precisely shaped to securely hold standard handlebars with ergonomic adjustability, is contemplated. Drill and tap a precision-engineered threaded hole into the handlebar clip-on, accurately aligned for receiving the securing bolt. Drill a matching unthreaded hole into the handlebar, aligned exactly with the threaded hole in the clip-on, enabling secure pinning. Manufacture a high-strength, vibration-resistant bolt sized specifically to thread through and pin securely into the handlebar hole. Securely mount front fork clip-on onto motorcycle forks. Position handlebar into handlebar clip-on, adjusting to ergonomic preference. Precisely align threaded hole and handlebar hole. Insert bolt through threaded hole into handlebar hole and securely tighten to lock handlebar position. Conduct visual and mechanical verification to confirm secure and immovable handlebar fixation.

Optional Elements may include the following: vibration-damping inserts or materials, specialized inserts or coatings reducing vibration for enhancing rider comfort. Quick-release or tool-free adjustment mechanisms may allow easier ergonomic adjustments without compromising secure locking. Color-Coded Components may be provided to facilitate quicker identification, installation, and compatibility across various motorcycle models. Integrated security locking mechanisms, such as a key-based or coded lock system to prevent unauthorized handlebar adjustments or theft. Modular or adjustable clip-on components are contemplated to provide different sizes or modular inserts to allow compatibility with diverse motorcycle fork or handlebar diameters. Embedded electronic components such as Bluetooth, LED indicators, or smartphone mounts to enhance rider experience and market value may be integrated with the control member stabilizing assembly 100.

Possible reconfigurations or interchangeability of components include reversible mounting orientation so that the fastener 40 could be reconfigured to insert from either side of the clip-on, providing identical secure locking capability while accommodating different motorcycle configurations or rider preferences (e.g., left-handed riders). Interchangeable engager 10 and 20 components could be produced in varied sizes, diameters, or shapes to accommodate different motorcycle models, fork dimensions, or handlebar styles, while preserving the core function of securely pinning the handlebar. Adjustable bolt length and threading for the fastener are contemplated for varying lengths and standardized threading could be interchanged to suit handlebars of different thicknesses or materials, providing the same mechanical pinning function across a broader range of handlebar dimensions and motorcycle types. Alternative fasteners or securing components (such as pins combined with separate locking nuts or quick-release pins) could replace or supplement the threaded bolt, performing an equivalent pinning and locking function to secure handlebar stability. Relocation or addition of threaded holes, including multiple threaded holes 25 could be strategically added or repositioned within the clip-on/second coupling component 20, allowing flexible ergonomic adjustments while maintaining the same secure pinning and positional stability function. Clip-ons/engagers could be modularized, allowing riders to interchange or attach additional modules, such as vibration-damping inserts or ergonomic extensions, without altering the core invention function of securely locking the handlebar.

Step-by-step instructions for using the subject disclosure: subject disclosure may include the following. Step 1: mount front fork clip-on securely onto the motorcycle's front fork, aligning it carefully to ensure stability and precise placement as the base for handlebar attachment. Step 2: insert handlebar into clip-on 20 by sliding or positioning the motorcycle handlebar 30 into the handlebar clip-on, adjusting it carefully to achieve the desired ergonomic angle, height, and rider-specific positioning. Step 3: precisely align the pre-drilled hole 35 in the handlebar 30 with the threaded hole 25 in the clip-on. This alignment is critical, enabling accurate pinning and secure fixation. Step 4: insert the bolt through the threaded hole in the clip-on, fully passing into and through the aligned hole in the handlebar. Tighten the bolt firmly using an appropriate tool, securely pinning the handlebar in the selected ergonomic position and permanently preventing rotational movement or slippage. Step 5: perform a final mechanical check by applying manual force to confirm that the handlebar remains securely locked, immovable, and precisely fixed in position, thereby confirming fully solving the problem of handlebar instability and rotation.

Additionally, innovative bolt-through pinning mechanism, designed originally for motorcycle handlebars, can be effectively adapted and utilized in multiple alternative fields to achieve secure positional locking, alignment stability, and prevention of unintended movement, rotation, or vibration. For example, bicycle and sports equipment for securing handlebars or seats in professional bicycles, racing bikes, or fitness equipment, providing athletes precise, stable, ergonomic positioning during high-stress or competitive scenarios. Medical and Surgical Equipment: Locking adjustable positioning devices for medical lights, monitors, or instrument trays in operating rooms or clinical settings, ensuring critical stability and precise alignment during sensitive medical procedures. Camera and Photography Equipment: Stabilizing high-precision camera or video gear mounts on tripods or rigs, preventing vibration, unintended rotation, or shifting, enhancing photographic precision and quality. Industrial Machinery and Robotics: Securing adjustable machine components, robotic joints, or precision alignment tools within industrial automation, manufacturing lines, or robotic assemblies, providing precise alignment and mechanical reliability. Marine and Aerospace Applications: Providing secure locking for boat steering assemblies, cockpit instrumentation mounts, or critical aerospace components, significantly improving stability and operational safety under vibration or dynamic stresses.

Also, the subject disclosure enables an ergonomic handlebar attachment device preventing unintended rotation. Additional Products and Devices: Bicycle Handlebar/Seat Assemblies: Stabilized, adjustable handlebars or seats for cycling. Medical Equipment Mounts: Secure mounts for surgical lighting, monitors, and trays. Photography Equipment Mounts: Stabilized tripod heads and camera mounts. Industrial Machinery Components: Locking mechanisms for robotic arms and precision industrial tools. Fitness Equipment Adjustment Systems: Secure positioning for exercise bikes, treadmills, or sports equipment. Marine/Aerospace Equipment Stabilizers: Adjustable locking assemblies for navigation and cockpit components. Construction and Tool Adjustments: Precision locking devices for adjustable power tools and equipment. Electronic Device Mounts: Secure mounts for smartphones, tablets, or display screens. Automotive Adjustable Components: Stabilized mirrors, seats, steering controls, or dashboard elements. Furniture and Office Equipment: Positional locking mechanisms for adjustable chairs, lamps, and shelves.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and 10 are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A handlebar locking assembly for a vehicle comprising:
a first coupling component configured to directly engage with and mechanically communicate the first coupling component relative to a steering axis component of the vehicle;
a second coupling component configured to directly engage with and mechanically communicate the second coupling component relative to an elongated control member of the vehicle;
wherein, in an unlocked state, an angular orientation of the elongated control member relative to the steering axis component is adjustable without tools;
a channel defined through at least a portion of the second coupling component, the channel being in communication with the elongated control member directly engaged by the first coupling component; and
a securing element configured to move within the channel between a disengaged position and an engaged position in which the securing element physically interferes with the elongated control member to lock said angular orientation in a locked state.

2. The handlebar locking assembly of claim 1, further comprising an attachment point along the elongated control member so that in the locked state the securing element physically and directly engages the attachment point.

3. The handlebar locking assembly of claim 2, wherein the first coupling component and the second coupling component are physically connected.

4. The handlebar locking assembly of claim 3, wherein the first coupling component provides a first engagement point that directly physically contacts the steering axis component of the vehicle.

5. The handlebar locking assembly of claim 4, wherein the second coupling component provides a second engagement point that directly engages with the elongated control member.

6. The handlebar locking assembly of claim 5, wherein the first engagement point is a first void that extends in a first direction.

7. The handlebar locking assembly of claim 6, wherein the second engagement point is a second void that extends in a second direction, approximately orthogonal relative to the first direction.

8. The handlebar locking assembly of claim 7, wherein the channel extends in a third direction, approximately orthogonal relative to the first direction and the second direction.

9. The handlebar locking assembly of claim 8, wherein the first coupling component and the first coupling component are each clips.

10. The handlebar locking assembly of claim 9, wherein the channel and the securing element are both complementarily threaded.

11. The handlebar locking assembly of claim 10, where, in the unlocked state, elongated control member is enabled to rotate, within the second void, about an axis of rotation extending in the second direction.

12. The handlebar locking assembly of claim 11, wherein the first coupling component and the second coupling component are fixed relative to each other.
